(19) United States
(12) Patent Application Publication
(10) Pub. No.: US 2006/0111513 A1
(43) Pub. Date: May 25, 2006

(54) Use of polyamide-based outer layers for production of inliners for refrigeration equipment

(76) Inventors: Frank Slansky, Remscheid (DE); Slaven Gojsic, Zagreb (HR); Volkhard Krause, Leverkusen (DE); Klaus Lorenz, Dormagen (DE); Gerwolf Quaas, Koln (DE)

Correspondence Address: LANXESS CORPORATION, 111 RIDC PARK WEST DRIVE, PITTSBURGH, PA, 15275-1112, US

(21) Appl. No.: 11/187,714

(22) Filed: Jul. 22, 2005

(30) Foreign Application Priority Data
Jul. 26, 2004 (DE) 1020040362483

(51) Int. Cl. B32B 27/34; B32B 27/32; C08L 77/00

(52) U.S. Cl. 525/178; 428/474.4; 428/521

(57) ABSTRACT

The invention relates to the use of plastics compositions based on mixtures of polyamide and ABS as outer layers on insulating foam for production of inliners for refrigeration equipment.

The present invention considerably reduces gas permeation through inliner materials. Concomitantly there is a significant delay in any reduction of the level of insulating properties of the foams in contact with the outer layers.

The insulating properties of the foam substantially determine the energy consumption of refrigeration equipment and its classification into a particular energy efficiency class. The present invention delays the rise in energy consumption of this type of equipment.

In the production of refrigeration equipment, inliner bodies composed of styrene-butadiene or in rare instances of acrylonitrile-butadiene-styrene are back-foamed with rigid polyurethane foam. The usual method here introduces the reaction mixture in suitable moulds into the space between inliner body and outer body, where it completes its reaction to give the foam. The blowing agent used to foam the reaction mixture is a mixture composed of physical blowing agents (hydrocarbons, HFTs, HFTCs), and CO₂. The latter is a “chemical” blowing agent usually resulting from the reaction of water, added to the reaction mixture, with the polyisocyanate. Rigid polyurethane foams blown exclusively by carbon dioxide are also known.

Once the foaming process has been completed, the CO₂ gas present in the foam cells diffuses through the inliner material as time progresses. At the same time, air, in essence a mixture of N₂ and O₂, penetrates from the external environment through the inliner material into the PU foam. However, the diffusion rate for this is smaller by about one order of magnitude. This process reduces the level of insulating properties of the refrigeration equipment, because the coefficient of thermal conductivity of air is substantially greater than the coefficient of thermal conductivity of CO₂. The consequences are an increase in the electricity consumption of the refrigeration equipment, the energy class stated by the manufacturer becoming inapplicable after a certain time. It has been found that PA/ABS-blends have markedly more favourable gas-barrier properties than the styrene-based thermoplastics currently used.

Inliners for refrigeration equipment are usually manufactured via a thermoforming process, from thermoplastic sheets. The sheets are manufactured from pellets (polystyrene-based thermoplastics) via extrusion. The inliner is then inserted, together with the preassembled outer body, into the foaming mould, and the PU reaction mixture which reacts to give the foam is then introduced into the space between inliner and outer body. In the resultant composite system, the inliner must comply with the optical, mechanical, and hygiene requirements of the refrigeration equipment producer. The PU foam securely bonded to the inliner provides the insulation properties required and bonds the inliner to the outer body.

The process described of diffusion of CO₂ and air through foam and inliner material leads, as explained above, to impairment of insulating properties of the rigid PU foam over time. The energy consumption of refrigeration equipment is decisively determined by the insulating action of the PU foam. The initial energy consumption determines the classification of the refrigeration equipment into energy efficiency classes, which are also used by the refrigeration equipment producer as a sales argument. Polyamide plastics mentioned in the literature exhibit a markedly lower level of permeation of the gases CO₂, N₂ and O₂ when compared with the plastics in standard use in refrigeration equipment, e.g. impact-modified polystyrene, or acrylonitrile-butadiene-styrene copolymers (ABS), and therefore delay the rise in energy consumption, and the process of “ageing” of the refrigeration equipment is slowed. However, straight polyamides have very limited use as inliner materials because of restrictions on the thermoformabaility of semicrystalline thermoplastics. Furthermore, polyamides are more susceptible than styrene-based plastics to scratching and therefore do not fully comply with the optical/hygiene requirements for inliners. It has been found that the gas-barrier properties of Triax® (registered-trademark product from Lanxess Deutschland GmbH), a blend of polyamide and acrylonitrile-butadiene-styrene copolymer, are at a markedly higher level, when comparison is made with the known plastics used for inliners: SB and ABS.

The invention provides the use of plastics compositions based on mixtures of polyamide and ABS as outer layer on insulating foam for production of inliners for refrigeration equipment.

The particular properties of the novel outer layer system are, as seen from the above statements, probably attributable to its polyamide content. Furthermore, the plastics mixture mentioned, the use of which is preferred, can be thermoformed with excellent results and therefore, with the combined properties of polyamide and ABS, has properties exceeding those of currently known inliner materials for refrigeration equipment. Triax is also, by way of example, coextrudable with ABS, and can therefore also be used in a thin layer as a highly permeation-resistant material.

The table below shows the particular properties of the outer layer.

Permation Performance of Various Outer Layer Materials with Respect to CO₂, N₂, O₂

| $\frac{{cm}^{2}}{s \cdot bar} \cdot {10}^{- 9}$ | CO₂ | N₂ | O₂ |
|---|---|---|---|
| SB* | 60 . . . 200 | 2 . . . 8 | 13 . . . 30 |
| ABS* | 20 . . . 70 | 0.8 . . . 1.8 | 1.8 . . . 8 |
| Triax 1120 | 2.2 | 0.1 | 0.9 |
| PA6* | 0.4 . . . 1.7 | 0.02 . . . 0.07 | 0.07 ... 0.2 |

*Table values from K. Oberbach “Kunststoffkennwerte für Konstrukteure” [Plastics properties for designers]

1. Use of plastics compositions based on mixtures of polyamide and ABS as outer layers on insulating foam for production of inliners for refrigeration equipment.
